(19) United States
(12) Patent Application Publication
(10) Pub. No.: US 2005/0210332 A1
(43) Pub. Date: Sep. 22, 2005

(54) Module with trigger bus for SOC tester and a method of timing calibration in the module

(75) Inventors: Tomonori Ura, Tokyo (JP); Masayuki Fukasawa, Tokyo (JP)

Correspondence Address: Paul D. Greeley, Esq.;Ohlandt, Greeley, Ruggiero & Perle, L.L.P., One Landmark Square, 10th Floor, Stamford, CT, 06901-2682, US

(73) Assignee: Agilent Technologies, Inc.

(21) Appl. No.: 11/050,581

(22) Filed: Feb. 3, 2005

(30) Foreign Application Priority Data
Mar. 18, 2004 (JP) 2004-78933

(51) Int. Cl. G06F 11/00

(52) U.S. Cl. 714/26

(57) ABSTRACT

A module in a module-type tester has a trigger bus for trigger signals and sub-modules; at least one of the sub-modules has a terminal for receiving trigger signals from the trigger bus and a terminal for outputting trigger signals to the trigger bus; and at least one of the sub-modules receives trigger signals from outside the module at a terminal for measurement signals or a terminal for signals under test and outputs the received trigger signals to the trigger bus via the output terminal.

### FIELD OF THE INVENTION

The present invention pertains to a module housed in a module-type tester and in particular, to a module that receives trigger signals.

### DISCUSSION OF THE BACKGROUND ART

Semiconductor testers are one example of a conventional module-type tester and have a test head, other measurement devices, a cooling device, a power source, and the like. The test head that is part of the semiconductor tester is the device that comes into contact with and measures the device under test (for instance, refer to Published Japanese translation of a PCT application 2001-512575 (FIG. 1)). A test head is shown in FIG. 1. Test head 200 in FIG. 1 has plural modules electrically connected to the terminal (not illustrated) of a device under test 100. Modules 210, 220, and 230 are shown in FIG. 1 as an example of these plural modules.

Next, refer to FIG. 2. FIG. 2 is a drawing that shows the internal structure of module 210. Module 210 in FIG. 2 has a signal input terminal 211 for receiving signals from the device under test 100, a multiplexer 212 connected to terminal 211, an analog to digital converter 213, a trigger signal input terminal 214, and a clock signal source 215. The signals under test that have been received at signal input terminal 211 are selected by multiplexer 212 and supplied to analog to digital converter 213. Trigger signals supplied from the device under test 100 or another device are supplied to clock signal source 215 via trigger signal input terminal 214. Clock signal source 215 outputs clock signals to analog to digital converter 213 in response to the input trigger signals. Moreover, analog to digital converter 213 converts the signals under test in accordance with the supplied clock signals.

There is now a need for semiconductor testers that are capable of conducting multi-site tests whereby plural devices under test are simultaneously measured. If a multi-site test is to be conducted, for instance, the inside of the module must have plural functions. When module 210 in FIG. 2 is described as an example, multiplexer 212 is removed from module 210 and plural analog to digital converters are directly connected to input terminal 211. The signals exchanged between the device under test 100 and module 210 include signals under test, which are signals from the device under test 100; measurement signals, which are signals applied to the device under test 100; and trigger signals. The number of trigger signal lines increases when module 210 has plural functions as described above. On the other hand, test head 200 shown in FIG. 1 has plural terminals (not illustrated) for electrical contact with the device under test 100. Moreover, the number of these terminals can be fixed in order to maintain an exchangeability of signals. Consequently, the fixed number of terminals limits the number of trigger signal lines that are to be exchanged between the device under test and the module; as a result, multi-site testing becomes difficult.

### SUMMARY OF THE INVENTION

A module housed inside a module-type tester characterized in that it has a terminal for measurement signals such that trigger signals can be received or a terminal for signals under test such that trigger signals can be received.

Moreover, the second embodiment is a module housed inside a module-type tester characterized in having a trigger bus for trigger signals, and a sub-module, which has a terminal for measurement signals or a terminal for signals under test and which is for receiving the trigger signals from outside the module at the terminal for measurement signals or at the terminal for signals under test and outputting the received trigger signals to the trigger bus.

The module housed inside a module-type tester, characterized in having a trigger bus for trigger signals and plural sub-modules for receiving trigger signals from the trigger bus.

At least one of the sub-modules has a terminal for measurement signals or a terminal for signals under test and the trigger signals from outside the module are received at this terminal for measurement signals or at the terminal for signals under test and the received trigger signals are output to the trigger bus.

A timing calibration method for the calibration of response timing of a module housed in a module-type tester and having a trigger bus for trigger signals, a sub-module for receiving trigger signals from outside the module and outputting them to the trigger bus, and a sub-module for receiving trigger signals from this trigger bus, this method comprising a step for generating trigger signals and inputting them to the module; a step for determining the phase or amount of propagation delay in the trigger signals received at each sub-module actually using trigger signals, and a step for adjusting the timing by which the sub-module responds to trigger signals in accordance with the determined phase or amount of propagation delay.

By means of the present invention, there are more functions in a module for the module-type tester while maintaining the exchangeability of the module-type tester; therefore, these functions can be used simultaneously.

### BRIEF DESCRIPTION OF THE DRAWINGS

FIG. 1 is a block diagram showing a conventional semiconductor tester.

FIG. 2 is a block diagram showing the modules inside a conventional semiconductor tester.

FIG. 3 is a block diagram showing module 300 of the first embodiment of the present invention.

FIG. 4 is a block diagram showing module 300 of the first embodiment of the present invention.

FIG. 5 is a block diagram showing module 900 of the second embodiment of the present invention.

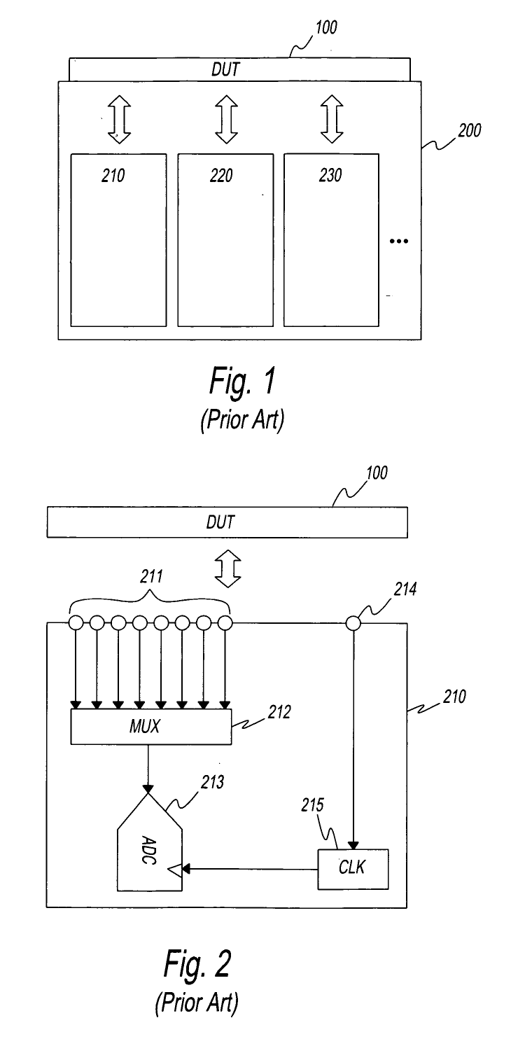

### DETAILED DESCRIPTION OF THE PREFERRED EMBODIMENT

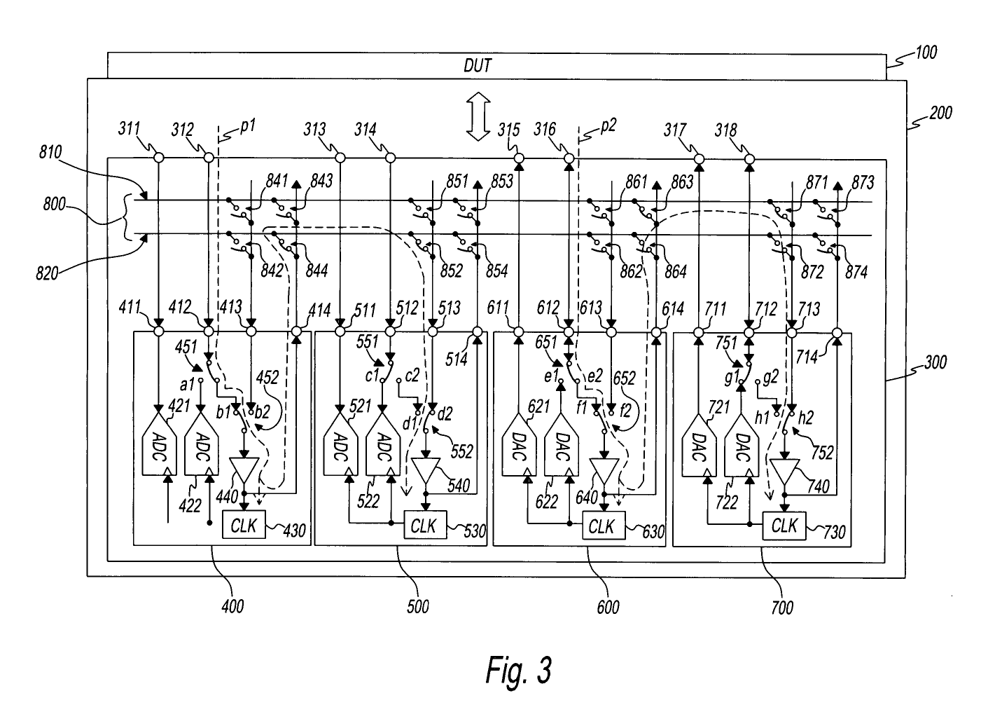

Embodiments of the present invention will now be described while referring to the attached drawings. The first embodiment of the present invention is the module of a module-type tester. Refer to FIG. 3. FIG. 3 is a block diagram showing a test head 200 for measuring a device under test 100. Test head 200 in FIG. 3 has a module 300 that is electrically connected with the device under test 100. Module 300 has a sub-module 400, a sub-module 500, a sub-module 600, a sub-module 700, and a trigger bus 800. Moreover, module 300 has a terminal 311, a terminal 312, a terminal 313, a terminal 314, a terminal 315, a terminal 316, a terminal 317, and a terminal 318. Terminal 312, terminal 313, terminal 314, terminal 315, terminal 316, terminal 317, and terminal 318 are electrically connected to the device under test 100, etc.

Sub-module 400 has an analog to digital converter 421, an analog to digital converter 422, a clock signal source 430, a comparator 440, a switch 451, and a switch 452. Moreover, sub-module 400 has a terminal 411, a terminal 412, a terminal 413, and a terminal 414. Terminal 411 is connected to terminal 311 and supplies the signals under test that have been received by terminal 311 to analog to digital converter 421. Terminal 412 is connected to terminal 312 and supplies the signals under test or the trigger signals that have been received by terminal 312 to switch 451. Switch 451 supplies the signals from terminal 412 to analog to digital converter 422 or switch 452. Switch 452 supplies either the signals from switch 451 or the signals from terminal 413 to comparator 440. Terminal 413 is connected to a trigger signal line 810 via a switch 841 and to a trigger signal line 820 via a switch 842. Trigger signal line 810 and trigger signal line 820 are signal lines that form a trigger bus 800. Comparator 440 evaluates the input signals based on a certain threshold value and outputs the evaluation results. The output signals of comparator 440 are supplied to clock signal source 430 and terminal 414. Terminal 414 is connected to trigger signal line 810 via a switch 843 and to trigger signal line 820 via a switch 844. Clock signal source 430 begins to supply clock signals to analog to digital converter 421 and analog to digital converter 422 in response to the output signals of comparator 440.

Sub-module 500 has an analog to digital converter 521, an analog to digital converter 522, a clock signal source 530, a comparator 540, a switch 551, and a switch 552. Moreover, sub-module 500 has terminals 511, 512, 513, and 514. Terminal 511 is connected to terminal 313 and supplies the signals under test received by terminal 313 to analog to digital converter 521. Terminal 512 is connected to terminal 314 and supplies the signals under test or the trigger signals received by terminal 314 to switch 551. Switch 551 supplies the signals from terminal 512 to analog to digital converter 522 or switch 552. Switch 552 supplies either the signals from switch 551 or the signals from terminal 513 to comparator 540. Terminal 513 is connected to trigger signal line 810 via switch 851 or trigger signal line 820 via switch 852. Comparator 540 evaluates the input signals based on certain threshold values and outputs the evaluation results. The output signals of comparator 540 are supplied to clock signal source 530 and terminal 514. Terminal 514 is connected to trigger signal line 810 via switch 853 and trigger signal line 820 via switch 854. Clock signal source 530 begins to supply the clock signals to analog to digital converter 521 and analog to digital converter 522 in response to the output signals of comparator 540.

Sub-module 600 has a digital to analog converter 621, a digital to analog converter 622, a clock signal source 630, a comparator 640, a switch 651, and a switch 652. Moreover, sub-module 600 has terminals 611, 612, 613, and 614. Terminal 611 is connected to terminal 315 and supplies the measurement signals output by digital to analog converter 621 to terminal 315. Terminal 612 is connected to terminal 316 and supplies the measurement signals output by digital to analog converter 622 to terminal 316. Moreover, terminal 612 supplies the trigger signals received by terminal 316 to switch 651. Switch 651 establishes an electrical connection between terminal 612 and either digital to analog converter 622 or switch 652. Switch 652 supplies either the signals from switch 651 or the signals from terminal 613 to comparator 640. Terminal 613 is connected to trigger signal line 810 via a switch 861 or to trigger signal line 820 via a switch 862. Comparator 640 evaluates the input signals based on certain threshold values and outputs the evaluation results. The output signals of comparator 640 are supplied to clock signal source 630 and terminal 614. Terminal 614 is connected to trigger signal line 810 via a switch 863 and to trigger signal line 820 via a switch 864. Clock signal source 630 begins to supply clock signals to digital to analog converter 621 and to digital to analog converter 622 in response to the output signals of comparator 640.

Sub-module 700 has a digital to analog converter 721, a digital to analog converter 722, a clock signal source 730, a comparator 740, a switch 751, and a switch 752. Moreover, sub-module 700 has terminals 711, 712, 713, and 714. Terminal 711 is connected to terminal 317 and supplies the measurement signals output by digital to analog converter 721 to terminal 317. Terminal 712 is connected to terminal 318 and supplies the measurement signals output by digital to analog converter 722 to terminal 318. Moreover, terminal 712 supplies the trigger signals received by terminal 318 to a switch 751. Switch 751 establishes an electrical connection between terminal 712 and either digital to analog converter 722 or a switch 752. Switch 752 supplies either the signals from switch 751 or signals from terminal 713 to comparator 740. Terminal 713 is connected to trigger signal line 810 via a switch 871 or to trigger signal line 820 via a switch 872. Comparator 740 evaluates the input signals based on certain threshold values and outputs the evaluation results. The output signals of comparator 740 are supplied to clock signal source 730 and terminal 714. Terminal 714 is connected to trigger signal line 810 via a switch 873 and to trigger signal line 820 via a switch 874. Clock signal source 730 begins to supply clock signals to digital to analog converter 721 and digital to analog converter 722 in response to the output signals of comparator 740.

Switch 451 in FIG. 3 selects the a2 side. Switch 452 selects the b1 side. Switches 844 and 852 are ON. Switch 551 selects the c1 side. Switch 552 selects the d2 side. As shown by the dashed arrow p1, the trigger signals received by terminal 312 are supplied to trigger line 820 via sub-module 400 and further supplied to sub-module 500 when these switches are selected. Moreover, switch 651 selects the e2 side. Switch 652 selects the f1 side. Switches 863 and 871 are ON. Switch 751 selects the g1 side. Switch 752 selects the h2 side. As shown by the dashed arrow p2, the trigger signals received by terminal 316 are supplied to trigger line 810 via sub-module 600 and further, to sub-module 700 when these switches are selected. In this case, three analog to digital conversions and three digital to analog conversions can be simultaneously executed.

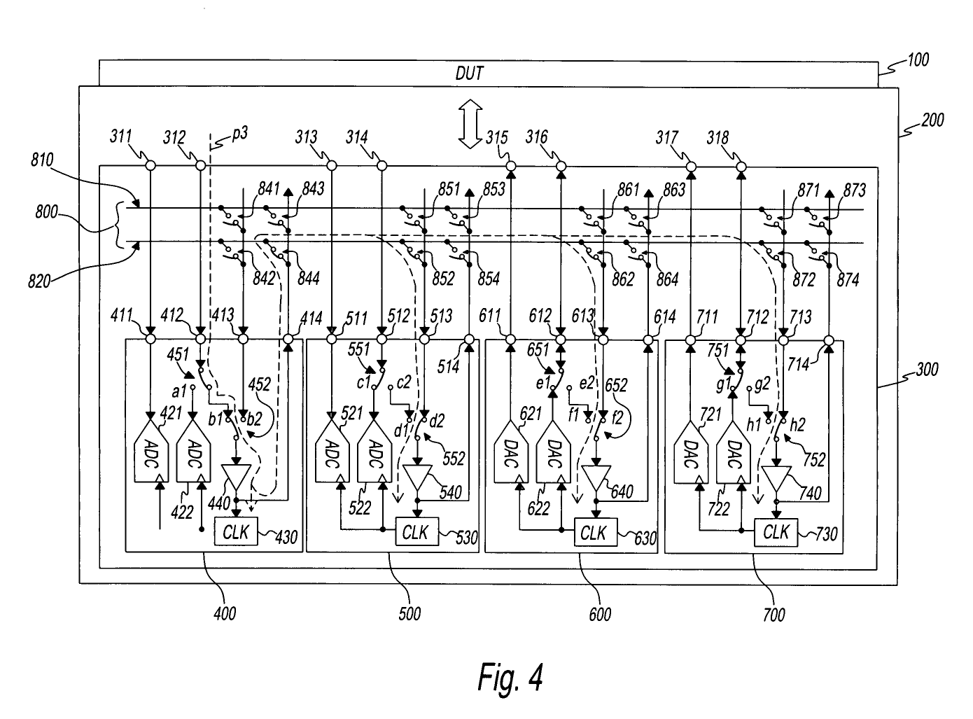

Next, FIG. 4 will be described. FIG. 4 is a drawing showing a test head 200 with the same structure as in FIG. 3. The difference between FIGS. 3 and 4 is the state of internal switch selection. Consequently, the same reference numbers are used for the structural elements in FIG. 3 that are the same as in FIG. 4 and a detailed description is not given. Switch 451 in FIG. 4 selects the a2 side. Switch 452 selects the b1 side. Switches 844 and 852 are ON. Switch 551 selects the c1 side. Switch 552 selects the d2 side. Switch 651 selects the e1 side. Switch 652 selects the f2 side. Switches 862 and 872 are ON. Switch 751 selects the g1 side. Switch 752 selects the h2 side. As shown by the dashed arrow p3, the trigger signals received by terminal 312 are supplied to trigger line 820 via sub-module 400 and further, to sub-modules 500, 600, and 700 when these switches are selected. In this case, three analog to digital conversions and four digital to analog conversions can be simultaneously executed.

If a special terminal for trigger signals is disposed at module 300, module 300 can simultaneously process only four conversions at most. By means of the present invention, the necessary number of terminals for signals under test or terminals for measurement signals are used as trigger terminals; therefore, even if there are plural functions (sub-modules) inside module 300, these functions (sub-modules) can be effectively used.

However, when module 300 has plural functions (sub-modules), trigger terminals may be necessary depending on these functions. In this case, a special trigger terminal can be disposed in the module.

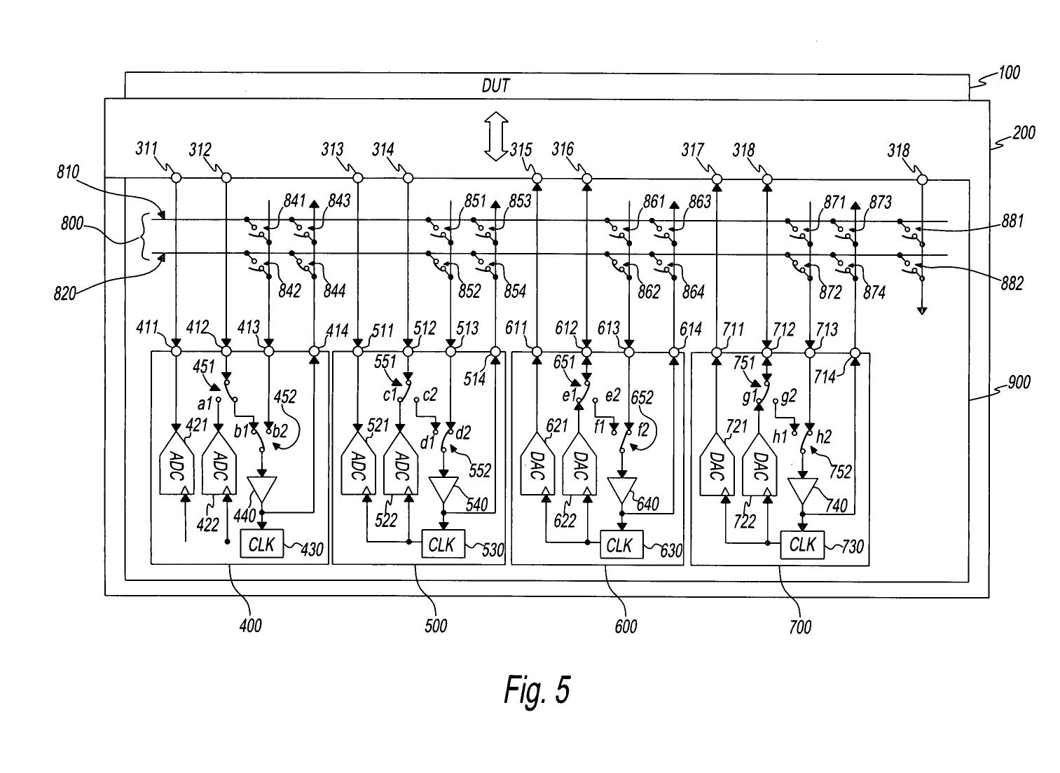

A second embodiment of the present invention will be described here in terms of a module with a special trigger terminal. Refer to FIG. 5. FIG. 5 is a block diagram showing a test head 200 for measuring a device under test 100. The same reference numbers are used for the structural elements in FIG. 5 that are the same as in FIG. 3 and a detailed description is not given. A module 900 is similar to module 300 shown in FIG. 3, except that here a special terminal 320 for trigger signals has been added. Trigger terminal 320 is connected to trigger signal line 810 via a switch 881 and to trigger signal line 820 via a switch 882. Trigger terminal 320 is electrically connected to the device under test 100, etc.

As previously described, module 900 has the minimum necessary number of trigger terminals; as a result, the number of terminals that process measurement signals or signals under test and trigger signals are reduced and the structure can be simplified. Of course, a number of other terminals process measurement signals or signals under test and trigger signals, and plural functions (sub-modules) inside module 900 can therefore be used as effectively as in the first embodiment.

Comparators 440, 540, 640, and 740 in the two embodiments described above can also be buffers.

As previously described, the modules in the present invention have a trigger bus inside and send and receive trigger signals between sub-modules. The response timing of each sub-module to the trigger signals received at a certain terminal therefore changes intricately with the switches that are selected. As a result, timing is calibrated once the selected switches are confirmed. Calibration is performed in accordance with the following procedure. That is, trigger signals are input to each terminal that is pre-determined for actual use, the phase or amount of propagation delay of trigger signals received at each sub-module that will actually use the trigger signals is determined, and the timing by which the sub-modules respond to trigger signals is adjusted in accordance with the determined phase or amount of propagation delay of the trigger signals. The response timing is adjusted by means of the delayed trigger signals. For instance, a delay element that can be controlled should be inserted between comparator 440 and the clock signal source in FIG. 3.

1. A module housed inside a module-type tester, said module comprising:
a terminal for measurement signals such that trigger signals can be received or a terminal for signals under test such that trigger signals can be received.

2. A module housed inside a module-type tester, said module comprising:
a structure in which sub-modules can be installed;
a bus for trigger signals between said sub-modules.

3. A module housed inside a module-type tester, said module comprising:
a trigger bus for trigger signals; and
a sub-module, which has a terminal for measurement signals or a terminal for signals under test, and which is used for receiving said trigger signals from outside said module either at said terminal for measurement signals or at said terminal for signals under test and outputting the received trigger signals to said trigger bus.

4. A module housed inside a module-type tester, said module comprising:
a trigger bus for trigger signals; and
a plurality of sub-modules for receiving trigger signals from said trigger bus.

5. The module according to claim 4, wherein at least one of said sub-modules has a terminal for measurement signals or a terminal for signals under test and the trigger signals from outside said module are received at either said terminal for measurement signals or at said terminal for signals under test and the received trigger signals are output to said trigger bus.

6. A timing calibration method for the calibration of response timing of a module housed in a module-type tester, said module comprising a trigger bus for trigger signals, a sub-module for receiving trigger signals from outside the module and outputting them to the trigger bus, and a sub-module for receiving trigger signals from said trigger bus, said method comprising:
generating trigger signals and inputting them to said module;
determining the phase or amount of propagation delay in said trigger signals received at each sub-module actually using trigger signals; and
adjusting the timing by which said sub-module responds to said trigger signals in accordance with the determined phase or amount of propagation delay.
